(19) United States
(12) Patent Application Publication
(10) Pub. No.: US 2008/0268951 A1
(43) Pub. Date: Oct. 30, 2008

(54) Data Visualization System for Fantasy Sporting Events

(76) Inventors: L. Christopher Gropp, Wilmington, DE (US); Danny Swartzbaugh, Bangor, ME (US); James Mowbray, Wilmington, DE (US); Jesse Beardsley, Newark, DE (US)

Correspondence Address: MCCARTER & ENGLISH, LLP, FOUR GATEWAY CENTER, 100 MULBERRY STREET, NEWARK, NJ, 07102, US

(21) Appl. No.: 12/101,408

(22) Filed: Apr. 11, 2008

Related U.S. Application Data
(62) Division of application No. 60/926,175, filed on Apr. 25, 2007.

(51) Int. Cl. A63F 13/02; A63F 13/12

(52) U.S. Cl. 463/31; 463/42

(57) ABSTRACT

A data visualization system for fantasy sporting events is provided, wherein participants of fantasy football leagues, etc., can quickly and conveniently view and compare statistics of various players, teams, and leagues using a single, easy-to-operate, graphical user interface that can be accessed using the Internet. Statistics pertinent to a fantasy sporting event can be viewed and compared and performance comparisons can be accomplished in a single screen through the graphical and/or tabular presentation of statistics. Team statistics can be ranked according to a common ranking algorithm which allows for comparisons of the relative performances of teams while taking into account specific scoring methodologies.

### RELATED APPLICATIONS

This application claims the benefit of U.S. Provisional Application Ser. No. 60/926,175, filed Apr. 25, 2007, the entire disclosure of which is expressly incorporated herein by reference.

### BACKGROUND OF THE INVENTION

1. Field of the Invention

The present invention relates to data visualization, and more particularly, to a data visualization system for allowing users to view and compare statistics relating to fantasy sporting events in a single, easy-to-operate, graphical user interface.

2. Related Art

Fantasy sporting events, such as fantasy football leagues, are a popular recreational activity, particularly among sports enthusiasts. In fantasy football, participants join a “league” and “draft” football players of existing National Football League (NFL) teams (e.g., players from the New York Giants, and other teams) to form a hypothetical team. The team then “competes” with the drafted teams of other fantasy football participants based upon the actual performance of the drafted NFL players during a football season. Typically, each league follows its own scoring methodology, such that the assembled team accumulates points which are usually based upon one or more performance statistics of the NFL players. The scoring methodologies can, and often do, vary from league to league.

Various Internet websites have been created for allowing fantasy football teams to track player statistics during a football season. Such websites allow league participants to log in and check his or her players' statistics. Additionally, such websites can be programmed to automatically calculate points in accordance with a particular league's scoring methodology. However, existing websites do not provide a robust data visualization feature, such that statistics of two or more players and/or teams can be graphically presented and compared in a single viewing area, a user can select desired players and/or teams using drag-and-drop actions, and the user can quickly toggle between multiple leagues, discern trends in the visualized data, and track and compare player and/or team statistics.

Accordingly, what would be desirable, but has not yet been provided, is a data visualization system for fantasy sporting events which address the aforementioned shortcomings of existing fantasy sports websites.

### SUMMARY OF THE INVENTION

The present invention relates to a data visualization system for fantasy sporting events. The system allows participants of fantasy sporting events, such as participants of fantasy football leagues, etc., to quickly and conveniently view and compare statistics of various players, teams, and leagues using a single, easy-to-operate, graphical user interface that can be accessed using the Internet. Participants can use the present invention to track fantasy sports statistics for one or more leagues, select one or more players and/or teams, and view and compare the performance of players and/or teams. Participants can use the system of the present invention to define customized scoring rules for one or more leagues, and can define group rules applicable to multiple leagues. Statistics are automatically calculated by the present invention in accordance with pre-defined league scoring methodologies, and are based upon the actual performance of players and/or teams in a real sporting event.

Numerous statistics pertinent to a fantasy sporting event can be viewed and compared, and can be filtered based upon one or more criteria. Performance comparisons of two or more players and/or teams can easily be accomplished in a single screen through the graphical and/or tabular presentation of statistics taken over user-selectable periods of time. The user can quickly toggle between multiple leagues and perform comparisons between players and/or teams of such leagues using the graphical user interface. Team statistics can be ranked according to a common ranking algorithm of the present invention.

### BRIEF DESCRIPTION OF THE DRAWINGS

These and other important features of the invention will be apparent from the following Detailed Description of the Invention, taken in connection with the accompanying drawings, in which:

FIG. 1 depicts a graphical user interface screen of the data visualization system of the present invention for allowing a user to select, view, and compare fantasy sports statistics;

FIGS. 2-3 show graphical user interface screens of the data visualization system of the present invention for graphically presenting player and/or team statistics to a user;

FIG. 4 depicts the “home” graphical user interface screen of the data visualization system of the present invention, displayed in a conventional web browser;

FIG. 5 depicts a graphical user interface screen of the data visualization system of the present invention for allowing a user to define league scoring rules;

FIG. 6 depicts a graphical user interface screen of the data visualization system of the present invention for displaying team statistics in one or more pie charts;

FIG. 7 is a diagram showing the overall software architecture and various software components of the data visualization system of the present invention;

FIG. 8 is a diagram showing a database schema (including various tables and field relationships therebetween) implemented by the present invention; and

FIG. 9 is a flowchart showing processing steps for implementing the common ranking methodology of the present invention.

### DETAILED DESCRIPTION OF THE INVENTION

The present invention relates to a data visualization system for fantasy sporting events, wherein participants of fantasy football leagues, etc., can quickly and conveniently view and compare statistics of various players, teams, and leagues using a single, easy-to-operate, graphical user interface that can be accessed using the Internet. Various statistics pertinent to a fantasy sporting event can be viewed and compared and performance comparisons can be accomplished in a single screen through the graphical and/or tabular presentation of statistics. The user can toggle between multiple leagues and perform comparisons between players and/or teams of such leagues using the graphical user interface. Team and/or league statistics can be ranked according to a common ranking algorithm of the present invention.

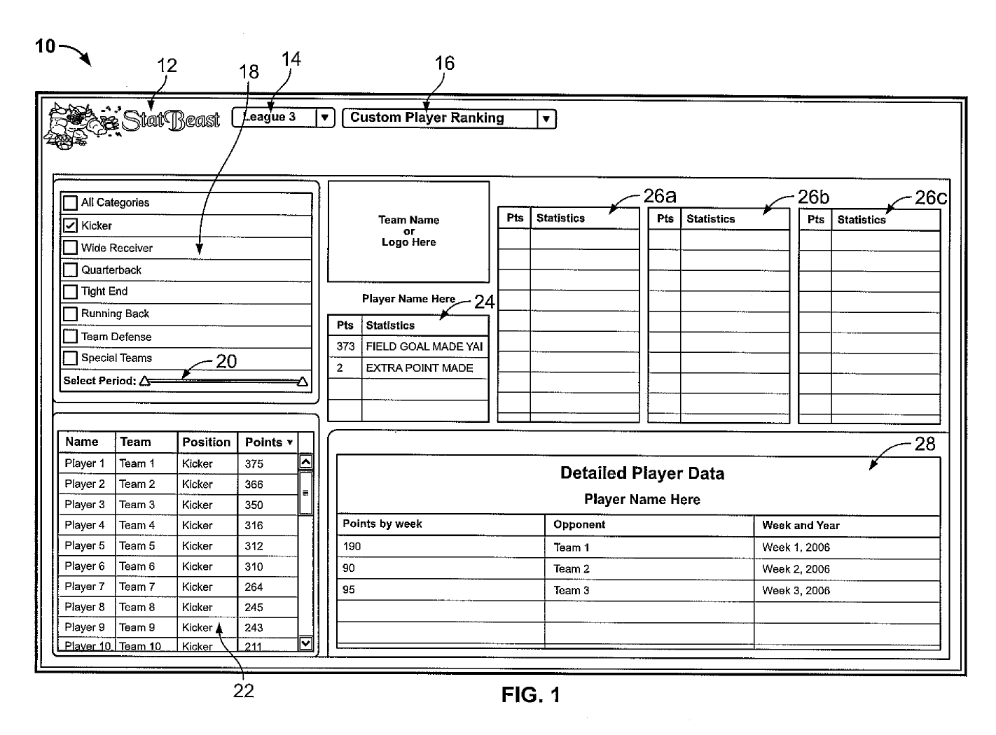

FIG. 1 depicts a graphical user interface screen of the data visualization system 10 of the present invention. By the term “visualization,” it is meant the graphical and/or tabular displaying of statistical information, including fantasy sports statistics, so that trends in such statistics can be easily discerned by a user. Also, it is noted that the present invention is not a conventional, online fantasy sports league, but rather, an Internet-accessible system for allowing fantasy sports statistics utilized by such leagues to be quickly and conveniently visualized by participants.

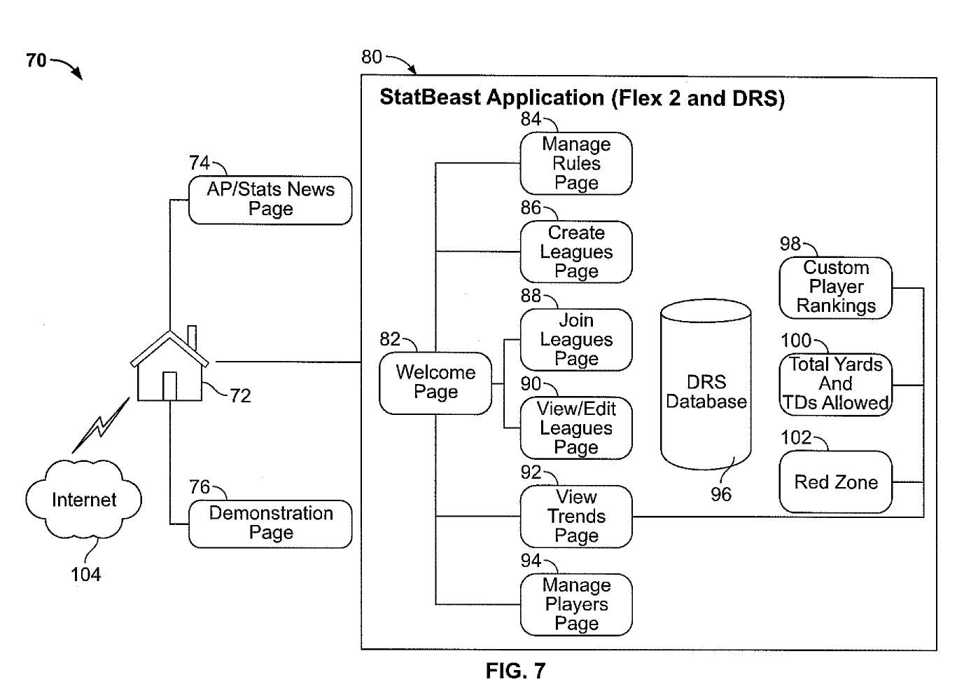

The screen includes a navigation “dashboard” 12 which includes a league selection menu pull-down button 14 and a ranking type pull-down button 16. The user can quickly and conveniently select a fantasy sports league of which the user is a member and for which the user wishes to track and compare player and/or team statistics by clicking on the pull-down button 14 and selecting a league. After a league has been selected, the user can select a type of ranking to be utilized. Examples of such types of ranking include, but are not limited to, customized player ranking (wherein data to be plotted is ranked utilizing a customized ranking method defined by the user and/or a league), or a common ranking methodology in accordance with the present invention, discussed below with reference to FIG. 7.

The screen also includes a player selection region 18 wherein a user can identify players based upon a position, including, but not limited to, all categories (i.e., display all players regardless of position), kicker, wide receiver, quarterback, tight end, running back, team defense, and special teams. Special teams can represent teams which include specific types of players. The region 18 also includes a period selection “slider” 20, wherein the user can select a desired time period for which to display statistics (e.g., beginning from a starting date and extending to an end date).

Screen region 22 displays the player name, team name, position, and points of all players which match the position criteria selected in region 18. When a user clicks on a player name in region 22, screen region 28 displays detailed data for the selected player, including, but not limited to, points by week, opponent name (i.e., name of team(s) against which the player recently played), and week(s) and/or year(s) associated with the displayed statistic.

To plot and compare (visualize) statistics about one or more players, the user clicks on a player name in screen region 22, and then “drags” and “drops,” using a computer mouse, the desired names to screen region 24. Thus, as shown in FIG. 1, a desired player name (e.g., “Player 1”) is dragged from region 22 to region 24, wherein the available statistics and points which can be plotted are displayed in region 24. Similarly, names of additional players can be dragged from screen region 22 to the screen regions 26a-26c, wherein available statistics and points which can be plotted are displayed in these regions. The same screen can be used to select team statistics to be displayed and compared.

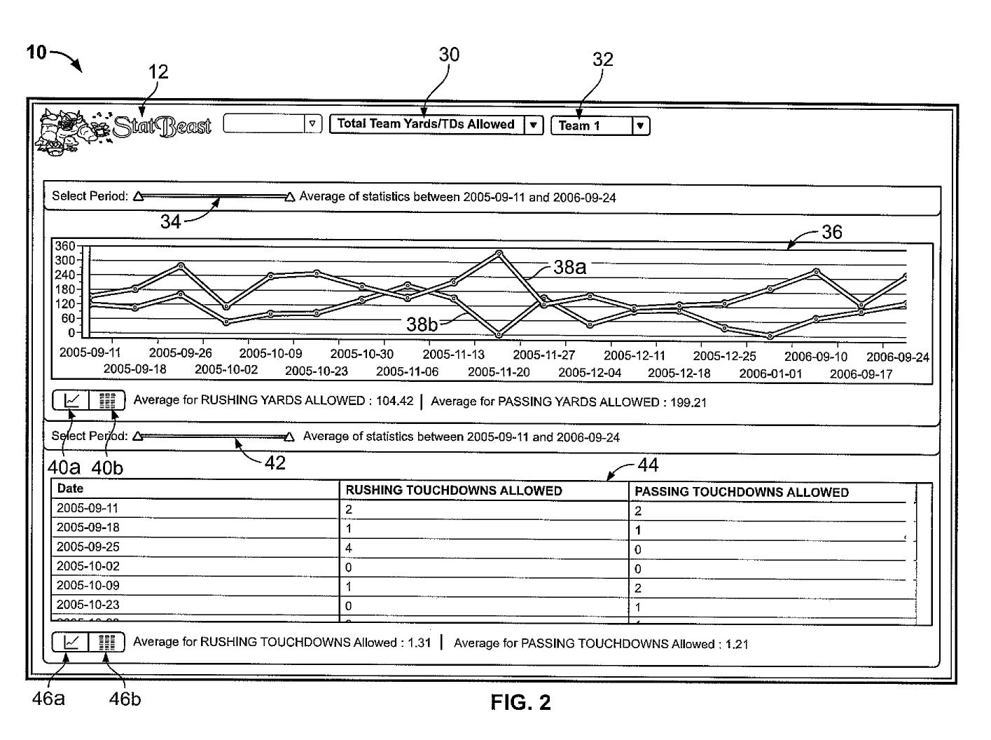

When a user has selected one or more desired players and/or teams for which to plot statistics, the graphical user interface screen depicted in FIG. 2 is displayed to the user. The dashboard 12 displays a menu pull-down button 30 which allows a user to select one or more statistics for a player and/or team to be displayed, such as total team yards, touchdowns allowed, and other statistics. The dashboard 12 also displays a menu pull-down button 32 which allows the user to select one or more teams for which statistics are to be displayed.

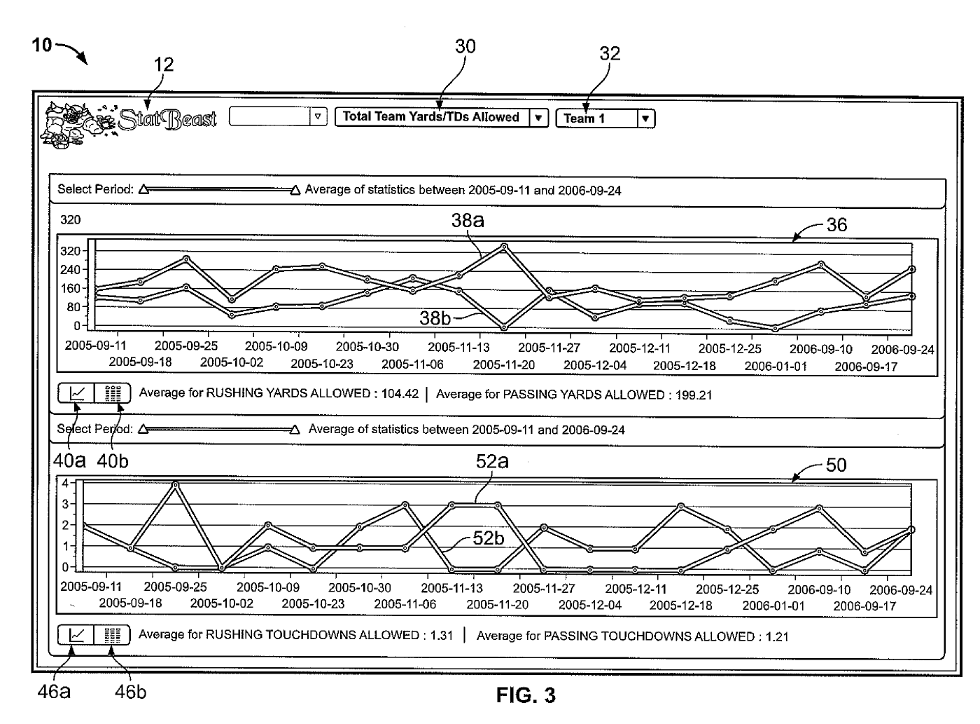

As shown in FIG. 2, a trend display region 36 is provided, wherein one or more desired player and/or team statistics can be displayed, either graphically or in table format, for a specified time period. As shown in region 36, two plots 38a and 38b of team statistics are graphically presented in a single graph. The first plot 38a shows passing and rushing yards allowed for a team (e.g., “Team 1”), and the second plot 38b shows passing and rushing touchdowns allowed for the same team. By clicking on buttons 40a and 40b, the user can toggle between graphical and tabular presentation of data. The trend display region 36 includes a slider 34 which allows the user to modify the time period for which to display statistics. As mentioned earlier, the plotted statistics could be ranked according to a customized (i.e., user-defined or league-defined) ranking methodology, or the common ranking methodology of the present invention discussed below. A second trend display region 44 is provided, wherein one or more player and/or team statistics corresponding to another player and/or team can be displayed, either graphically or in table format, for a specified time period selectable by the user using slider 42. As shown in FIG. 2, the data in the region 44 is displayed in tabular format. However, the user could easily toggle between tabular and graphical format by clicking on the buttons 46a and 46b. Thus, as shown in FIG. 3, the tabular data in region 44 of FIG. 2 could be displayed graphically in trend display region 50 as plots 52a and 52b. As can be appreciated, the system 10 of the present invention allows for the convenient displaying and comparison of statistical data of various players and/or teams, and for quickly toggling between various presentations of data. It should be noted that more than two trend display regions could be displayed in the screens depicted in FIGS. 2-3, thus allowing trends for numerous players and/or teams to be displayed and compared in a single, easy-to-operate screen.

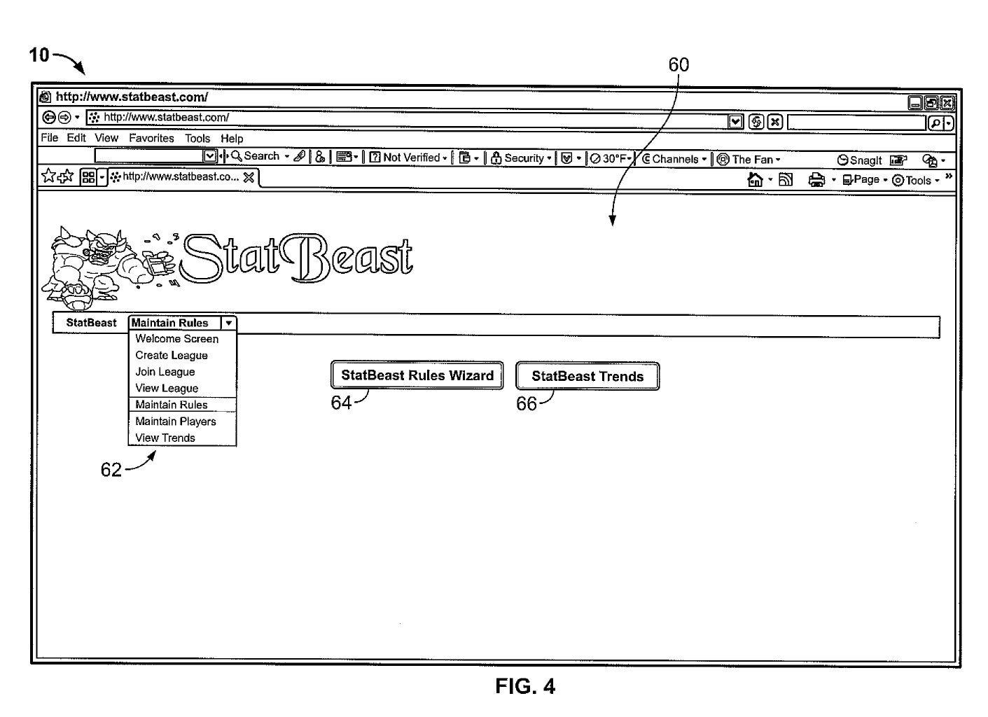

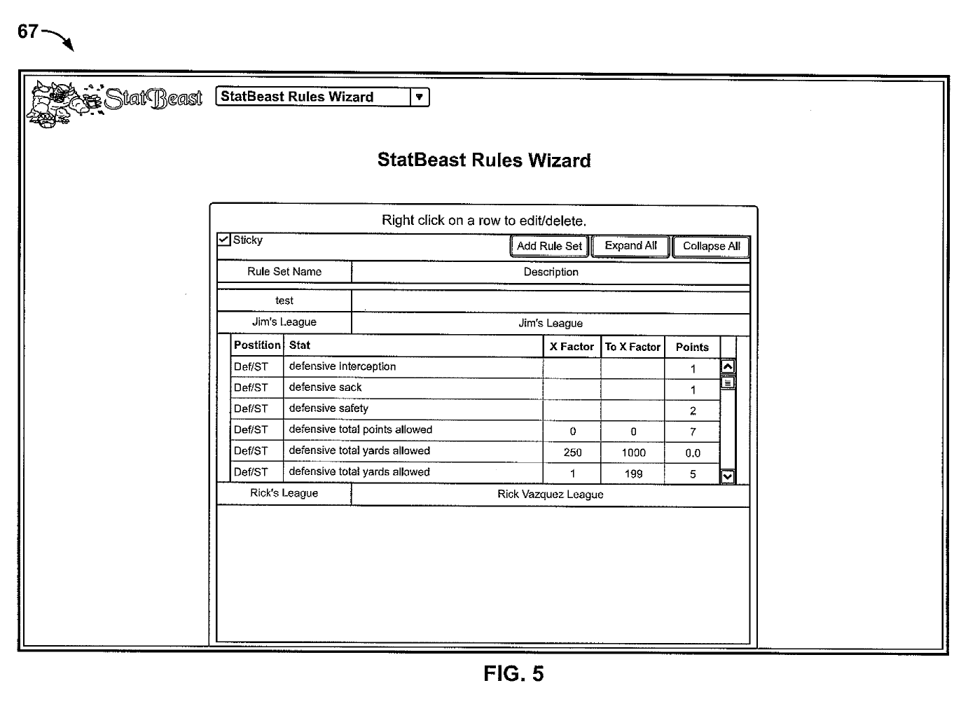

FIG. 4 depicts the “home” graphical user interface screen of the data visualization system 10 of the present invention, displayed in a conventional web browser. The screen includes a home display region 60, which could display a general welcome message to the user and/or one or more advertisements. A pull-down menu 62 allows the user to enter one or more pages, including, but not limited to, a “Maintain Rules” page (which allows participants of a league to define and/or modify league rules); the welcome page displayed in FIG. 4; a “Create League” screen (which allows participants to create a league for which data is to be visualized); a “Join League” screen (which allows users to join one or more groups of individuals utilizing the present invention); a “Maintain Players” page (which allows participants to select and manage players); and a “View Trends” page (which allows participants to view one or more statistical trends of players and/or teams, as discussed above). Also provided is a “Rules Wizard” button 64 and a “Trends” button 66. The button 64, when clicked on by a user, activates a screen (“wizard”) for allowing a user to define scoring rules for one or more leagues (discussed below with reference to FIG. 5). The button 66, when clicked, allows the user to view trends utilizing the interface screens discussed above in connection with FIGS. 1-3.

FIG. 5 depicts a graphical user interface screen 67 according to the present invention for allowing a user to define scoring rules for one or more leagues. An easy-to-use “wizard” screen is provided, which allows the user to add a rule set for each desired league. The rule sets define scoring rules for a particular league. Thus, for example, a rule could define a player position, an associated statistic, points associated with each statistic, and other information. Any desired number of rules, for any desired number of leagues, could be created using the screen 67.

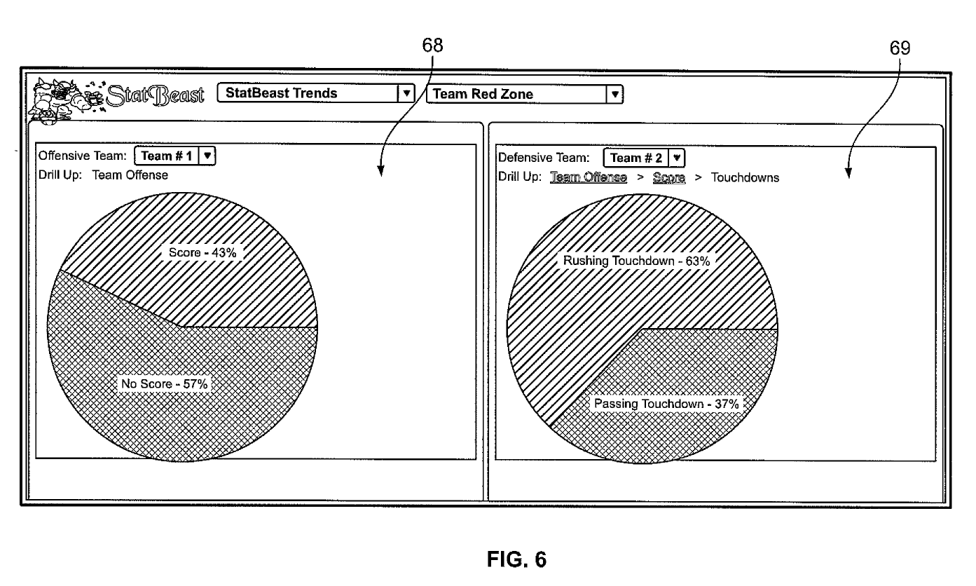

FIG. 6 depicts a graphical user interface screen for presenting statistics using pie charts, such as pie charts 68 and 69. As shown, the pie chart 68 illustrates score statistics for a first team (“Team 1”) and the pie chart 69 illustrates touchdown statistics of a second team (“Team 2”). The charts 68 and 69 allow for the quick comparison of statistics across multiple teams.

FIG. 7 is a diagram showing the overall software architecture and various software components of the data visualization system of the present invention. The present invention can be embodied as a software application 70 (referred to as the “StatBeast Application”), and can be coded using any suitable computer programming language, including hypertext markup language (HTML), the Flex 2 Internet application framework (by Adobe, Inc.), and a suitable, commercially-available, dynamic, real-time statistics (DRS) software package. Of course, other software applications could be utilized without departing from the spirit or scope of the present invention. The application 70 could be hosted by one or more servers running any suitable operating system, such as Microsoft Windows Server, Linux, Unix, Mac OS, or any other suitable operating system. The application could be accessed via the Internet 104 using any suitable remote computing device operable by a participant of a fantasy sporting event, such as a personal computer, a personal digital assistant (PDA), a wireless computing device, a cellular telephone, or any other suitable device. Moreover, the application could operate locally on a user's computing device, and it could be provided on any suitable, computer-readable medium.

The application 70 is accessed via a home website 72 having one or more dedicated URL addresses. Optionally, access to a news page 74 (which could include news provided by the Associated Press (AP) and could be entitled “AP/Stats News Page”) as well as a demonstration page 76 (for purposes of demonstrating the features of the present invention to a potential user) could also be provided at the home website 72. The application 70 is in communication with the website 72, and could execute on the same computer system hosting the website 72. The application 70 includes a welcome page 82 (similar to that depicted in FIG. 4) and one or more of the aforementioned pages discussed above in connection with the pull-down menu 62 of FIG. 4, including a Manage Rules page 84, a Create Leagues page 86, a Join Leagues page 88, a View/Edit Leagues page 90, a View Trends page 92, and a Manage Players page 94. One or more of these pages could be provided using a customized, easy-to-use rules definition page or software “wizard” which allows rules for one or more leagues, or groups of leagues, to be defined. As discussed above, the Manage Rules page 84 allows a user to define custom league rules. The Create Leagues page 86 allows a user to create a league, which comprises a group of users who utilize the present invention via a common account and who are bound by the same league rules.

The View Trends page 92 allows the user to track, display, and compare fantasy sports statistics in the manner discussed herein in connection with FIGS. 1-3, after the user has either created a league using the Create Leagues page 86 or joined an existing league using the Join Leagues page 88, and the user has selected one or more desired players and/or teams using the Manage Players page 94. The sports statistics displayed using the View Trends page 92 is automatically scored in accordance with a particular league's scoring methodology, and could be ranked using the common ranking methodology of the present invention discussed below or a customized player ranking rule 98, which could be defined by the user or by a league. As shown in connection with FIGS. 1-3 and discussed above, the visualized data could be filtered by one or more desired attributes, using a data filter such as the total yards and allowed touchdowns filter 100. Other filters and/or ranking methodologies could of course be implemented without departing from the spirit or scope of the present invention, such as a “Red Zone” filter 102 which allows for the visualization and comparison of sports statistics associated with a player or a team and occurring within a pre-defined range of an opponent's territory (e.g., number of plays occurring between an opponent's 20 yard line and the opponent's end zone). A DRS database 96 stores all data associated with the application 70.

Examples of the types of data trends that can be visualized by the present invention include, but are not limited to, the following:
Individual Trends—Visualization of an individual player's performance relative to a custom league rule
Offensive Trends—Visualization of the offensive performance of a team or a player, including yards and forced touchdowns, by week (e.g., rushing touchdowns, passing touchdowns, rushing yards, and passing yards), “Red-Zone” trends (e.g., forced scoring percentage, forced passing touchdowns, forced rushing touchdowns, forced field goals, and associated yard lines of execution), performance trends based upon position of a player (e.g., running backs, wide receivers, tight-ends, quarterbacks, and kickers), and any customized, user-defined scoring metric defined by a league.
Defensive Trends—Visualization of the defensive performance of a team or player, including yards and allowed touchdowns (e.g., rushing touchdowns, passing touchdowns, rushing yards, and passing yards), “Red-Zone” trends (e.g., scoring allowed percentages, allowed passing touchdowns, allowed rushing touchdowns, allowed field goals, and associated yard lines of execution), performance trends based upon position of a player, and any customized, user-defined scoring metric defined by a league.

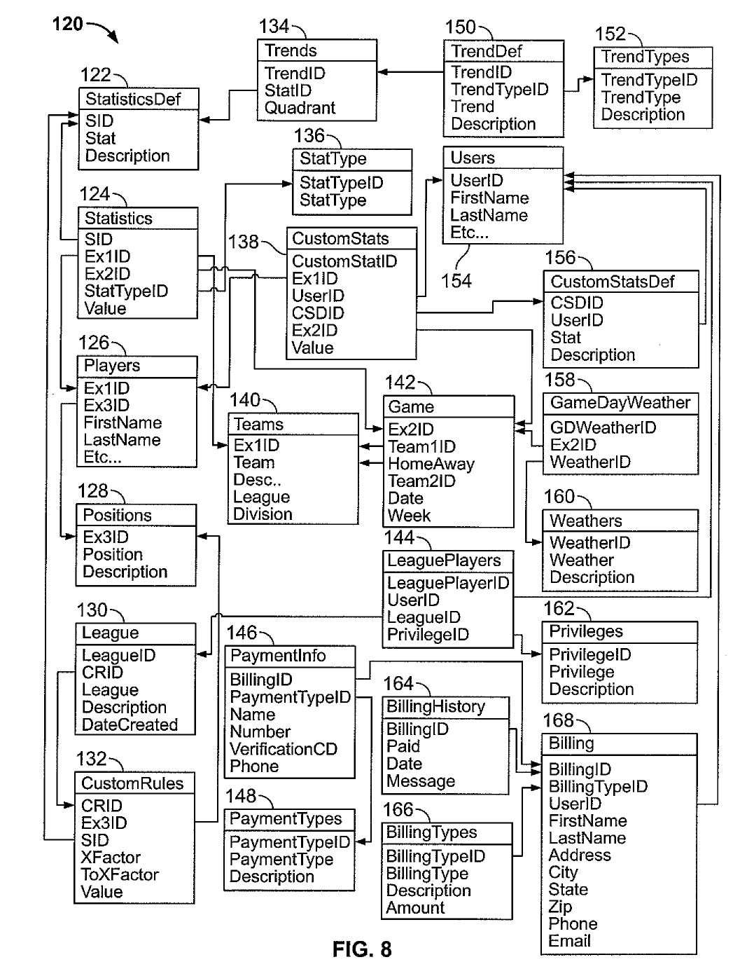

FIG. 8 is a diagram showing a database schema (including various tables and field relationships therebetween) implemented by the present invention, indicated generally at 120. The statistical data visualized by the present invention can be stored in a plurality of database tables (e.g., within the DRS database 96 of FIG. 5), each of which are indexed by a specific field of information. The database and its associated tables and field relationships could be implemented using any suitable, commercially-available relational database management system (DBMS) package, such as Microsoft SQL Server, Oracle, MySQL, or any other suitable package. The relational links between the tables shown in FIG. 6 are illustrated by the arrows interconnecting the tables. The tables could include, but are not limited to, a statistics definition table 122, a statistics storage table 124, a players table 126, a positions table 128, a league table 130, a custom rules table 132, a trends table 134, a statistics type table 136, a customized statistics table 138, a teams table 140, a game table 142, a league players table 144, a payment information table 146, a payment type table 148, a trend definition table 150, a trend type table 152, a users table 154, a custom statistics definition table 156, a game day weather table 158, a weather description table 160, a privileges table 162, a billing history table 164, a billing types table 166, and a billing table 168.

Tables 122, 124, 132, 134, 136, 138, 146, 148, 150, 152, 154, 156, 162, 164, 166, and 168 are dynamic database tables, and the fields of these tables are described below.

TABLE 122
(stores information about each statistic)

| Field Name | Type (and Length) | Description of Field |
|---|---|---|
| SID | Varchar(32) | The table identifier. |
| Stat | Varchar(100) | The statistic being defined. |
| Description | Varchar(254) | A description for the statistic |
| | | being defined. |

TABLE 124
(stores values for a given statistic)

| Field Name | Type (and Length) | Description of Field |
|---|---|---|
| SID | Varchar(32) | A link to the StatisticsDef table. |
| Ex1ID | Varchar(32) | A link to an application specific |
| | | table. |
| Ex2ID | Varchar(32) | A link to an application specific |
| | | table. |
| StatTypeID | Varchar(32) | A link to the StatType table. |
| Value | Varchar(20) | A value assigned to this custom |
| | | statistic. |

TABLE 132
(stores values for a given custom rule)

| Field Name | Type (and Length) | Description of Field |
|---|---|---|
| CRID | Varchar(32) | The table identifier. |
| Ex3ID | Varchar(32) | A link to an application specific |
| | | table. |
| SID | Varchar(32) | A link to the statistics table. |
| XFactor | double | A numeric starting point value. |
| ToXFactor | double | A numeric ending point value. |
| Value | double | A value assigned to this custom rule. |

TABLE 134
(assigns a statistic to a trend; defines a quadrant of the
application in which the trend should be placed)

| Field Name | Type (and Length) | Description of Field |
|---|---|---|
| TrendID | Varchar(32) | The table identifier. |
| StatID | Varchar(32) | A link to the StatisticsDef table. |
| Quadrant | Set(0, 1, 2, 3, 4) | The quadrant to place this |
| | | trend (0 = none). |

TABLE 136
(stores the different types of statistics
that can be used in the application)

| Field Name | Type (and Length) | Description of Field |
|---|---|---|
| StatTypeID | Varchar(32) | The table identifier. |
| StatType | Varchar(50) | The statistic type being defined. |

TABLE 138
(stores values for a given custom statistic)

| | Type | |
|---|---|---|
| Field Name | (and Length) | Description of Field |
| CustomStatID | Varchar(32) | The table identifier. |
| Ex1ID | Varchar(32) | A link to an application specific table. |
| UserID | Varchar(32) | A link to the Users table. |
| CSDID | Varchar(32) | A link to the CustomStatsDef table. |
| Ex2ID | Varchar(32) | A link to an application specific table. |
| Value | Varchar(20) | A value assigned to this custom statistic. |

TABLE 146
(stores payment information for the bill being paid)

| | Type | |
|---|---|---|
| Field Name | (and Length) | Description of Field |
| BillingID | Varchar(32) | A link to the Billing table. |
| PaymentTypeID | Varchar(32) | A link to the PaymentType table. |
| Name | Varchar(100) | The name for this payment. |
| Number | Varchar(50) | The number for this payment type. |
| VerificationCD | char(3) | The verification code, if there is one. |
| Phone | Varchar(12) | The phone number for this payment |
| | | type. |

TABLE 148
(stores the types of payment that can be used)

| Field Name | Type (and Length) | Description of Field |
|---|---|---|
| PaymenTypeID | Varchar(32) | The table identifier. |
| PaymentType | Varchar(100) | The type of payment this is. |
| Description | Varchar(254) | A description for this type of |
| | | payment. |

TABLE 150
(stores definition of trends for a given trend type)

| Field Name | Type (and Length) | Description of Field |
|---|---|---|
| TrendID | Varchar(32) | The table identifier. |
| TrendTypeID | Varchar(32) | A link to the TrendTypes table. |
| Trend | Varchar(50) | Name of the trend being defined. |
| Description | Varchar(254) | A description for the trend being |
| | | defined. |

TABLE 152
(defines the different types of trends)

| Field Name | Type (and Length) | Description of Field |
|---|---|---|
| TrendTypeID | Varchar(32) | The table identifier. |
| TrendType | Varchar(50) | The trend type to be defined. |
| Description | Varchar(254) | A description for the trend type |
| | | being defined. |

TABLE 154
(contains all personal information about users registered with the
application)

| | Type | |
|---|---|---|
| Field Name | (and Length) | Description of Field |
| UserID | Varchar(32) | The table identifier. |
| UserName | Varchar(30) | A name for the user to use in the application. |
| Password | Varchar(32) | The password for this user. |
| Cookie | Varchar(32) | A cookie assigned to the user (security |
| | | measures). |
| Session | Varchar(32) | Session assigned to the user (security |
| | | measures). |
| IP | Varchar(15) | IP address assigned to this user (security |
| | | measures). |
| FirstName | Varchar(30) | The user's first name. |
| LastName | Varchar(50) | The user's last name. |
| Address | Varchar(100) | The user's address. |
| City | Varchar(50) | The user's city. |
| State | Varchar(2) | The user's state. |
| Zip | Varchar(5) | The user's zip. |
| Phone | Varchar(12) | The user's phone number. |
| Email | Varchar(100) | The user's e-mail. |

TABLE 156
(stores definitions for each statistic)

| Field Name | Type (and Length) | Description of Field |
|---|---|---|
| CSDID | Varchar(32) | The table identifier. |
| UserID | Varchar(32) | A link to the Users table. |
| Stat | Varchar(100) | The statistic being defined. |
| Description | Varchar(254) | A definition for the statistic. |

TABLE 162
(stores definitions for each privilege)

| Field Name | Type (and Length) | Description of Field |
|---|---|---|
| PrivilegeID | Varchar(32) | The table identifier. |
| Privilege | Varchar(50) | The type of privilege. |
| Description | Varchar(254) | A description of the privilege. |

TABLE 164
(stores audit data for user billing)

| Field Name | Type (and Length) | Description of Field |
|---|---|---|
| BillingID | Varchar(32) | Links to the Billing table. |
| Paid | tinyint(1) (Boolean) | Indication whether user paid the |
| | | current bill. |
| Date | date | The date of the bill. |
| Message | Varchar(254) | An internal administration message |
| | | about the bill. |

TABLE 166
(stores information about the method of payment being used)

| Field Name | Type (and Length) | Description of Field |
|---|---|---|
| BillingTypeID | Varchar(32) | The table identifier. |
| BillingType | Varchar(100) | The type of payment being used. |
| Description | Varchar(254) | A description of the type of |
| | | payment. |
| Amount | decimal(8.2) | The total of the payment. |

TABLE 168
(stores user billing information)

| Field Name | Type (and Length) | Description of Field |
|---|---|---|
| BillingID | Varchar(32) | The table identifier. |
| BillingTypeID | Varchar(32) | Links to the BillingType table. |
| UserID | Varchar(32) | Links to the Users table. |
| FirstName | Varchar(30) | The user's billing first name. |
| LastName | Varchar(50) | The user's billing last name. |
| Address | Varchar(100) | The user's billing address. |
| City | Varchar(50) | The user's billing city. |
| State | Varchar(2) | The user's billing state. |
| Phone | Varchar(12) | The user's billing phone. |
| Email | Varchar(100) | The user's billing email. |

Tables 126, 128, 130, 140, 142, 144, 158, and 160 are application-specific tables, and the fields of these tables are described below.

TABLE 126
(stores personal information about the players in this application)

| Field Name | Type (and Length) | Description of Field |
|---|---|---|
| Ex1ID | Varchar(32) | The table identifier. |
| TeamID | Varchar(32) | A link to the Teams table. |
| Ex3ID | Varchar(32) | A link to the Positions table. |
| FirstName | Varchar(30) | The player's first name. |
| LastName | Varchar(50) | The player's last name. |
| NickName | Varchar(50) | The player's nick name. |
| Image | Varchar(100) | Image name (link to image for |
| | | application). |

TABLE 128
(defines positions for a sport)

| Field Name | Type (and Length) | Description of Field |
|---|---|---|
| Ex3ID | Varchar(32) | The table identifier. |
| Position | Varchar(30) | The position being defined. |
| Description | Varchar(254) | A description of the position |
| | | being defined. |

TABLE 130
(defines leagues and associated sets of rules)

| | Type | |
|---|---|---|
| Field Name | (and Length) | Description of Field |
| LeagueID | Varchar(32) | The table identifier. |
| CRID | Varchar(32) | A link to the CustomRules table. |
| League | Varchar(50) | The name of the league being defined. |
| Description | Varchar(254) | A description of the league being defined. |
| DateCreated | Timestamp | The date and time of creation of the league. |

TABLE 140
(defines a team for a sport)

| | Type | |
|---|---|---|
| Field Name | (and Length) | Description of Field |
| Ex1ID | Varchar(32) | The table identifier. |
| Team | Varchar(50) | The team being defined. |
| Description | Varchar(254) | A description of the team being defined. |
| League | Varchar(5) | Name of the league for this team. |
| Division | Varchar(5) | Name of the division for this team. |

TABLE 142
(contains information about game dates and opposing teams)

| Field Name | Type (and Length) | Description of Field |
|---|---|---|
| Ex2ID | Varchar(32) | The table identifier. |
| Team1ID | Varchar(32) | A link to the Teams table. |
| HomeAway | Varchar(4) | Indication whether game played at |
| | | home or away. |
| Team2ID | Varchar(32) | A link to the Teams table. |
| Date | date | The date the game was played. |
| Week | tinyint(2) | The week of the season the game |
| | | was played. |

TABLE 144
(stores all players in a given league and their privileges)

| Field Name | Type (and Length) | Description of Field |
|---|---|---|
| LeaguePlayerID | Varchar(32) | The table identifier. |
| UserID | Varchar(32) | A link to the Users table. |
| LeagueID | Varchar(32) | A link to the League table. |
| PrivilegeID | Varchar(32) | A link to the Privilege table. |

TABLE 158
(stores information about weather conditions for a game)

| | Type | |
|---|---|---|
| Field Name | (and Length) | Description of Field |
| GDWeatherID | Varchar(32) | The table identifier. |
| Ex2ID | Varchar(32) | A link to the Game table. |
| WeatherID | Varchar(32) | A link to the Weather table. |

TABLE 160
(defines weather types)

| Field Name | Type (and Length) | Description of Field |
|---|---|---|
| WeatherID | Varchar(32) | The table identifier. |
| Weather | Varchar(50) | Name of the weather being defined. |
| Description | Varchar(254) | Description of the weather being |
| | | defined. |

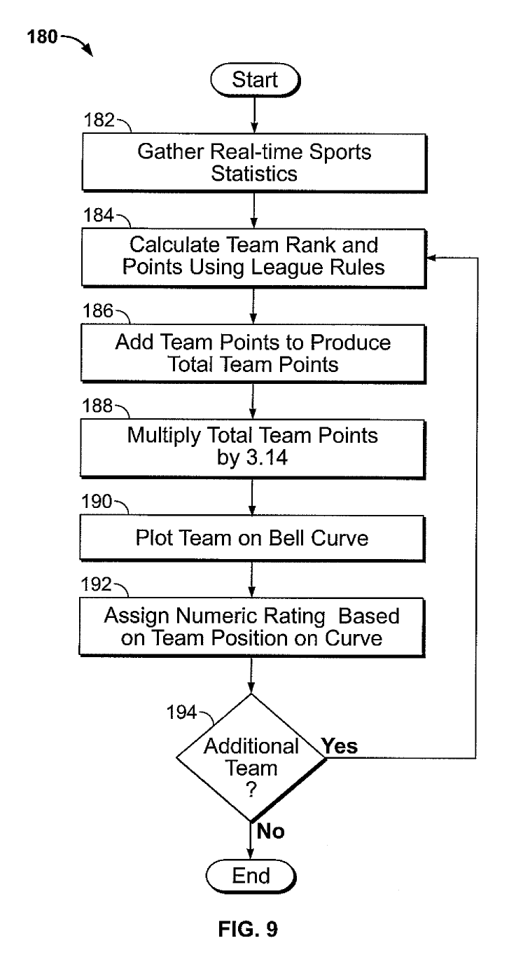

FIG. 9 is a flowchart, indicated generally at 180, showing processing steps for implementing the common ranking algorithm of the present invention. Advantageously, the common ranking algorithm of the present invention allows the relative performances of teams and/or players in fantasy sporting events to be compared, while taking into account the particular scoring methodologies implemented by such leagues. In step 182, real-time sports statistics (i.e., statistics corresponding to a real sporting event) are gathered. Then, in step 184, team rank and points are calculated using pre-defined rules applicable to a given league. In step 186, team points are added to produce a total number of team points. In step 188, the total number of team points is multiplied by 3.14. In step 190, the multiplied team points are plotted on a bell curve. By the term “plotted,” it is meant that the multiplied team points are compared to a bell curve distribution of other teams in a given league to determine the position of the team with respect to other teams. In step 192, a numeric rating is assigned to the team based upon its position on the bell curve. In step 194, a determination is made as to whether an additional team is to be ranked in accordance with the common ranking methodology. If a positive determination is made, steps 184-194 are repeated. The calculated common ranking could be conveyed to the user using one or more of the graphical user interface screens of the present invention. Additionally, ranking of teams could be accomplished by ranking total team scores in ascending order, and assigning a numeric ranking to each team.

Having thus described the invention in detail, it is to be understood that the foregoing description is not intended to limit the spirit and scope thereof. What is desired to be protected by Letters Patent is set forth in the appended claims.

What is claimed is:

1. A system for visualizing data relating to a fantasy sporting event, comprising:
a central server in communication with a remote computing device operable by a participant of a fantasy sporting event;
a first graphical user interface screen generated at least in part by the central server and displayed by the remote computing device for allowing the participant to select a plurality of desired fantasy sports players for which visualization of fantasy performance trends is desired, the first graphical user interface screen including:
a first screen region for allowing the participant to filter a list of fantasy sports players based upon a player position to produce a filtered list of fantasy sports players;
means for allowing the participant to specify a time period for which to visualize fantasy performance trends for the plurality of desired fantasy sports players; and
a second screen region for allowing the participant to select the plurality of desired fantasy sports players by clicking on the plurality of desired fantasy sports players from the filtered list of fantasy sports players, dragging the plurality of desired fantasy sports players to the second screen region, and dropping the plurality of desired fantasy sports players on the second screen region;
means at the central server for calculating the fantasy performance trends for the plurality of desired fantasy sports players for the time period specified by the participant; and
a second graphical user interface screen generated at least in part by the central server and displayed by the remote device for graphing the fantasy performance trends.

2. The system of claim 1, wherein the central server calculates the fantasy performance trends using a league scoring rule and actual performance statistics of real sports players corresponding to the plurality of desired fantasy sports players.

3. The system of claim 1, wherein the central server executes a ranking algorithm for ranking fantasy sports teams based upon performances of the teams, and displays team rankings to the participant.

4. The system of claim 1, farther comprising a third graphical user interface screen generated by the central server for allowing the participant to create a team of fantasy sports players and to define scoring rules for the team.

5. The system of claim 1, wherein the second graphical user interface screen further comprises means for adjusting the time period for which to display fantasy performance trends.

6. The system of claim 5, wherein the second graphical user interface screen further comprises a tabular display region for displaying fantasy performance trends in tabular format.

7. A computer-readable medium having stored thereon instructions for performing the steps comprising:
displaying a first graphical user interface screen operable by a participant of a fantasy sporting event for allowing the participant to select a plurality of desired fantasy sports players for which visualization of fantasy performance trends is desired;
filtering a list of fantasy sports players based upon a player position specified by the participant to produce a filtered list of fantasy sports players;
displaying the filtered list to the participant using a first screen region of the first graphical user interface screen;
allowing the participant to specify a time period for which to visualize fantasy performance trends for the plurality of desired fantasy sports players using the first graphical user interface screen;
allowing the participant to select the plurality of desired fantasy sports players by clicking on desired fantasy sports players in the filtered list of fantasy sports players, dragging the desired fantasy sports players to a second screen region of the first graphical user interface screen, and dropping the desired fantasy sports players on the second screen region;
calculating the fantasy performance trends for the plurality of desired fantasy sports players for the time period specified by the participant; and
graphing the fantasy performance trends in a second graphical user interface screen.

8. The computer-readable medium of claim 7, wherein the step of calculating the fantasy performance trends comprises calculating the fantasy performance trends using a league scoring rule and actual performance statistics of real sports players corresponding to the plurality of desired fantasy sports players.

9. The computer-readable medium of claim 7, further comprising the step of ranking fantasy sports teams based upon performances of the teams.

10. The computer-readable medium of claim 9, further comprising the step of displaying team rankings to the participant.

11. The computer-readable medium of claim 7, further comprising the step of displaying a third graphical user interface screen for allowing the participant to create a team of fantasy sports players and to define scoring rules for the team.

12. The computer-readable medium of claim 7, further comprising the step of displaying fantasy performance trends in tabular format in the second graphical user interface screen.

13. A method for visualizing data relating to a fantasy sporting event, comprising the steps of:
displaying to a participant of a fantasy sporting event a first graphical user interface screen on a computing device for allowing the participant to select a plurality of desired fantasy sports players for which visualization of fantasy performance trends is desired;
allowing the participant to filter a list of fantasy sports players based upon a player position specified by the participant to produce a filtered list of fantasy sports players;
displaying the filtered list to the participant using a first screen region of the first graphical user interface screen;
allowing the participant to specify a time period for which to visualize fantasy performance trends for the plurality of desired fantasy sports players using the first graphical user interface screen;
allowing the participant to select the plurality of desired fantasy sports players by clicking on desired fantasy sports players in the filtered list of fantasy sports players, dragging the desired fantasy sports players to a second screen region of the first graphical user interface screen, and dropping the desired fantasy sports players on the second screen region;
calculating the fantasy performance trends for the plurality of desired fantasy sports players for the time period specified by the participant; and
graphing the fantasy performance trends in a second graphical user interface screen.

14. The method of claim 13, wherein the step of calculating the fantasy performance trends comprises calculating the fantasy performance trends using a league scoring rule and actual performance statistics of real sports players corresponding to the plurality of desired fantasy sports players.

15. The method of claim 13, further comprising the step of ranking fantasy sports teams based upon performances of the teams.

16. The method of claim 15, further comprising the step of displaying team rankings to the participant.

17. The method of claim 13, further comprising the step of displaying a third graphical user interface screen for allowing the participant to create a team of fantasy sports players and to define scoring rules for the team.

18. The method of claim 13, further comprising the step of displaying fantasy performance trends in tabular format in the second graphical user interface screen.
